(19) United States
(12) Patent Application Publication
(10) Pub. No.: US 2008/0238295 A1
(43) Pub. Date: Oct. 2, 2008

(54) ELECTROLUMINESCENT DEVICE, METHOD OF MANUFACTURING THE DEVICE, ELECTRONIC DEVICE, THIN-FILM STRUCTURE, AND METHOD OF FORMING THIN FILM

(75) Inventors: Shuichi TAKEI, Shimosuwa-machi (JP); Yuji CHINO, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/046,719

(22) Filed: Mar. 12, 2008

(30) Foreign Application Priority Data
Mar. 29, 2007 (JP) 2007-086786

(51) Int. Cl. H01J 1/62; B05D 5/12

(52) U.S. Cl. 313/499; 427/66

(57) ABSTRACT

An electroluminescent device includes a substrate having a bank-forming face on one surface thereof, a bank formed on the bank-forming face, and a thin-film layer constituting an electroluminescent element at a region surrounded by the bank. The thin-film layer is formed by filling the region surrounded by the bank with a thin-film material liquid and solidifying the liquid. The bank-forming face and a contact face with the thin-film layer have curved surfaces so that the central portions thereof are convexed toward the substrate side.

### BACKGROUND

1. Technical Field

The present invention relates to an electroluminescent device including an electroluminescent element such as an EL (electroluminescent) element using an organic semiconductor film or an LED (light-emitting diode) element and relates to a method of manufacturing the electroluminescent device. The invention further relates to an electronic device including the electroluminescent device, a thin-film structure, and a method of manufacturing a thin film.

2. Related Art

In manufacturing of EL elements, color filters, and so on, technology for obtaining functional elements have been developed. In such technologies, thin-film layers that are independent of each other or have different characteristics are formed on a single substrate by coating or the like so as to have a predetermined pattern. In one effective method, for example, different thin-film patterns are formed on a single substrate using an ink-jet system.

However, the above-mentioned ink-jet system has a problem in its process. That is, a plurality of liquid materials for different thin films (hereinafter referred to as thin-film material liquid) is mixed on the substrate. Specifically, a technology using an ink-jet system is used for application of thin-film material liquids, for example, organic semiconductor materials for luminescent elements such as EL elements or display elements and colored resins for color filters. However, in a case that a thin-film pattern is formed by ejecting a thin-film material liquid using an ink-jet system, there is a problem that the ejected thin-film material liquid penetrates to the adjacent pixel.

In general, these problems are avoided by forming a convex bank as a partition member for partitioning different thin-film regions and filling each region surrounded by the bank with a thin-film material liquid for forming a thin-film layer. For example, in the above-mentioned display element, a bank is formed to partition each color region, and each region surrounded by the bank is filled with a thin-film material liquid for constituting a pixel.

However, recent functional elements, in particular, luminescent elements and display elements are generally required to have a small thickness. Accordingly, the height of the bank is restricted. However, the region surrounded by the bank is filled with a significantly large amount of thin-film material liquid compared to the volume after the formation of a film. Consequently, imbalance between the volume of a droplet to be ejected to a region surrounded by a bank and the areas of the bank surface and the region surrounded by the bank causes the following problems.

That is, in a case that the bank has a lyophilicity or wettability to the thin-film material liquid to be filled with, the final thin-film layer cannot have a desired thickness, even if the bank is formed, because the liquid is pulled by the bank. Furthermore, the thin-film material liquid readily flows out to the adjacent region, if the amount of the thin-film material liquid is increased. On the other hand, the surface of the region surrounded by the bank is required to have high lyophilicity and wettability to the thin-film material liquid so that the thin-film material liquid can uniformly spread and wet the surface. If not, the thin-film material liquid cannot spread and wet the region surrounded by the bank to cause decoloration or irregular color in pixels, in particular, in display elements such as EL elements.

Japanese Patent No. 3328297 (Patent Document 1) proposes to form a bank having a vertical two-layer structure composed of an upper portion being repellent to a thin-film material liquid and a lower portion being lyophilic, or to impart liquid repellency or lyophilicity to the bank by surface treatment such as plasma treatment or ultraviolet irradiation treatment.

However, the method described in Patent Document 1 is not sufficient for handling recently developed elements having high fineness. That is, in technology fields in which the above-described thin-film-forming technologies are used, in particular, in a field manufacturing luminescent elements, such as organic EL elements, or display elements, thin films are required to be significantly smaller in size in association with the elements becoming finer and finer. Accordingly, for example, even if the method described in Patent Document 1 is conducted using the above-mentioned ink-jet system, it is gradually becoming difficult to precisely form a thin-film layer having a uniform thickness in a significantly small area. For example, in an organic EL element, the resolution will be changed from the present 128 ppi to 180, 240, and 300 ppi in accordance with the miniaturization of elements. The miniaturization of elements causes decreases in pixel pitch and pixel size, and thereby the pixel aperture will have a width in the range of 20 to 40 μm, which is equivalent to or less than the size, 10 ng/shot, of the present ink droplet.

Therefore, for example, as shown in FIG. 5, in a case that a bank 3 having a double-layer structure composed of a lower layer 31 and a upper layer 32 is formed on a substrate 1 having an electrode, such as an anode 2, on the surface thereof as a bank-forming face and a thin-film layer, for example, a hole-transporting layer 41 constituting an organic EL layer 4, is formed by filling the inside of the bank 3 with a thin-film material liquid using an ink-jet system, the thin-film material liquid wets and spreads on the bank walls to form a concave (U-letter shape) recess 41a, as shown in the figure, on the surface of the hole-transporting layer 41 after drying. The recess 41a causes a difference in the thickness of the hole-transporting layer 41, namely, the central portion and the peripheral portion have different thicknesses, and thereby unevenness of brightness occurs in a pixel. Furthermore, the width of a region (thin-film-forming region) surrounded by the bank is decreased in accordance with higher fineness, and thereby the flat area is significantly narrowed. Consequently, a uniform emission profile is difficult to be obtained. Furthermore, the thickness of the peripheral portion of a pixel tends to become very large, and thereby light may not be emitted. On the other hand, the thickness of the central portion of the pixel is small, resulting in an uneven thickness.

### SUMMARY

An advantage of some aspects of the invention is that an electroluminescent device that can have a substantially uniform thickness can be provided, even if a thin-film layer having very small dimensions is formed for meeting to higher fineness. Furthermore, a method of manufacturing the electroluminescent device, an electronic device including the electroluminescent device, a thin-film structure, and a method of forming a thin film are also provided.

An electroluminescent device, a method of manufacturing the device, an electronic device, a thin-film structure, and a method of forming a thin film according to an embodiment of the invention are as follows. Specifically, the electroluminescent device according to an aspect of the invention includes a substrate having a bank-forming face on one surface thereof, a bank formed on the bank-forming face, and a thin-film layer constituting an electroluminescent element at a region surrounded by the bank. The thin-film layer is formed by filling the region surrounded by the bank with a thin-film material liquid and solidifying the liquid. The bank-forming face and a contact face with the thin-film layer have curved surfaces so that the central portions thereof are convexed toward the substrate side.

As described above, since the bank-forming face at a region surrounded by the bank and a contact face with the thin-film layer have curved surfaces so that the central portions thereof are convexed toward the substrate side, the bank-forming face at the region surrounded by the bank is provided with a concave being convexed toward the substrate side at the central portion, and, accordingly, the bottom face of the thin-film layer is curved so that the substantially central portion is convexed toward the substrate side. Furthermore, the top face of the thin-film layer formed by filling the region surrounded by the bank with the thin-film material liquid and solidifying the liquid is usually provided with a concave recess as aforementioned. Consequently, the thin-film layer can have a substantially uniform thickness not having a difference in the thicknesses of the central portion and the peripheral portion. As a result, for example, electroluminescent elements such as organic EL elements can have a uniform emission profile without unevenness of brightness.

The curved surface is preferably formed so as to have a shape substantially identical to that of a recess on the surface (top face) of the thin-film layer. With such a shape, the thin-film layer can have a further uniform thickness.

The bank can have a structure including a lower layer that is lyophilic to the thin-film material liquid and an upper layer that is repellent to the thin-film material liquid. The liquid repellency of the upper bank layer allows the thin-film material liquid to be definitely applied. Specifically, the liquid repellency of the upper bank layer prevents a thin-film material liquid filled in a region surrounded by the bank from flowing out and migrating to the adjacent region and from causing confusion or color mixing. In addition, the lyophilicity of the lower bank layer increases the wettability of the lower bank layer to allow the thin-film material liquid to evenly spread to the bank side faces. As a result, the thin-film layer can have a top face suitably provided with a predetermined concave or a U-letter shape, and the thickness of the thin-film layer and the shape of the recess are stabilized to further uniformize the thickness of the thin-film layer.

The lower layer of the bank is preferably made of an inorganic material such as SiO₂ or SiN, and the upper layer of the bank is preferably made of an organic material such as an acrylic resin or a polyimide resin. In the lower layer made of such as an inorganic material, the contact angle of the thin-film material liquid to the bank can be decreased by treating the surface of the lower layer with oxygen plasma, and high lyophilicity (wettability) can thus be attained. In the upper layer made of such as an organic material, the contact angle of the thin-film material liquid to the bank can be selectively increased by treating the surface of the upper layer with fluorine gas plasma such as CF₄ plasma, and high liquid repellency can thus be attained.

The side face of the lower bank layer and the side face of the upper bank layer preferably form a substantially single flat surface. When the lower layer and the upper layer thus form a substantially single flat surface not to form unevenness therebetween, a thin-film layer is not formed on the side face of the upper layer having liquid repellency and is formed only on the side face of the lower layer having lyophilicity, in the region surrounded by the bank. With such a single flat surface, a thin-film layer is not formed on the top face of the lower bank layer, and the thin-film layer is not exposed to the outside of the region surrounded by the bank. As a result, the thin-film layer is prevented from spreading to the outer side than the anode inside the bank.

The bank-forming face includes an electrode formed on the substrate and can have a structure in which the aforementioned curved surface (concave) is formed at least on the surface of the electrode. With such a structure, a functional element such as an organic EL element can be formed on the surface of the electrode on the substrate.

The thin-film layer can be an organic EL layer constituting an organic EL element as the electroluminescent element. As a result, the organic EL element can have a uniform emission profile without unevenness of brightness.

A method of manufacturing the electroluminescent device according to an aspect of the invention includes forming a bank on a bank-forming face and filling a region surrounded by the bank with a thin-film material liquid and solidifying the liquid to form a thin-film layer constituting an electroluminescent element, wherein a concave is formed on the surface of the region surrounded by the bank, and the thin-film layer is formed on the concave.

Since the thin-film layer is formed on the concave formed on the surface of the region surrounded by the bank, the bottom face of the thin-film layer is curved along the concave so that the central portion thereof has a convex that is convexed downward. Furthermore, the top face of the thin-film layer is provided with a concave recess as described above in the process of forming the thin-film layer. Therefore, the central portion and the peripheral portion of the thin-film layer can simply and certainly have substantially the same thicknesses. As a result, for example, an electroluminescent element such as an organic EL element can have a uniform emission profile without unevenness of brightness.

The bank-forming face is constituted with a substrate having an electrode on the surface thereof and has a structure in which the aforementioned concave is formed at least on the surface of the electrode. In this case, the concave may be formed directly on the surface of the electrode or may be formed by forming a concave on the surface at the electrode side of the substrate and forming the electrode as a thin film on the concave so that the shape of the concave of the substrate is reproduced on the surface of the electrode to form a concave on the surface of the electrode.

The region surrounded by the bank can be filled with the thin-film material liquid using an ink-jet system. The use of an ink-jet system allows a thin-film material to relatively readily fill the region surrounded by the bank, even if the size of the region becomes smaller and smaller in accordance with the above-mentioned higher fineness.

An organic EL layer constituting an organic EL element as the electroluminescent element can be formed by filling the region surrounded by the bank with the thin-film material liquid and solidifying the liquid. As a result, the organic EL element having a uniform emission profile without unevenness of brightness can be readily manufactured.

An electronic device according to an aspect of the invention can have a structure including such as an aforementioned electroluminescent device. With such a structure, an electronic device including the electroluminescent device having a uniform emission profile without unevenness of brightness can be provided.

A thin-film structure according to an aspect of the invention includes a substrate having a bank-forming face on one surface thereof, a bank formed on the bank-forming face, and a thin-film layer formed by filling a region surrounded by the bank with a thin-film material liquid and solidifying the liquid, and is characterized by that the bank-forming face and a contact face with the thin-film layer have curved surfaces so that the substantially central portions thereof are convexed toward the substrate side. According to such a structure, a thin-film structure having a substantially uniform thickness can be provided.

In a method of forming a thin film according to an aspect of the invention, a bank is formed on a bank-forming face, and a thin-film layer is formed by filling a region surrounded by the bank with a thin-film material liquid and solidifying the liquid, wherein the surface of the region surrounded by the bank is concaved. According to this method of forming a thin film, a thin-film layer having a substantially uniform thickness can be simply and certainly formed.

### BRIEF DESCRIPTION OF THE DRAWINGS

The invention will be described with reference to the accompanying drawings, wherein like numbers reference like elements.

FIG. 1 is a longitudinal sectional view illustrating an electroluminescent device according to an embodiment of the invention.

FIGS. 2A to 2E are explanatory diagrams illustrating an example of a process for forming a substrate and an anode.

FIGS. 3A to 3D are explanatory diagrams illustrating an example of a process for manufacturing the electroluminescent device.

FIG. 4 is a perspective view illustrating an electronic device according to an embodiment of the invention.

FIG. 5 is a cross-sectional view illustrating a structure of a known thin-film layer.

### DESCRIPTION OF EXEMPLARY EMBODIMENTS

In accordance with embodiments of the invention, an electroluminescent device, a method of manufacturing the device, an electronic device including the electroluminescent device or an electroluminescent device manufactured by the method, a thin-film structure, and a method of manufacturing the thin film will be specifically described with reference to the accompanying figures.

### Electroluminescent Device

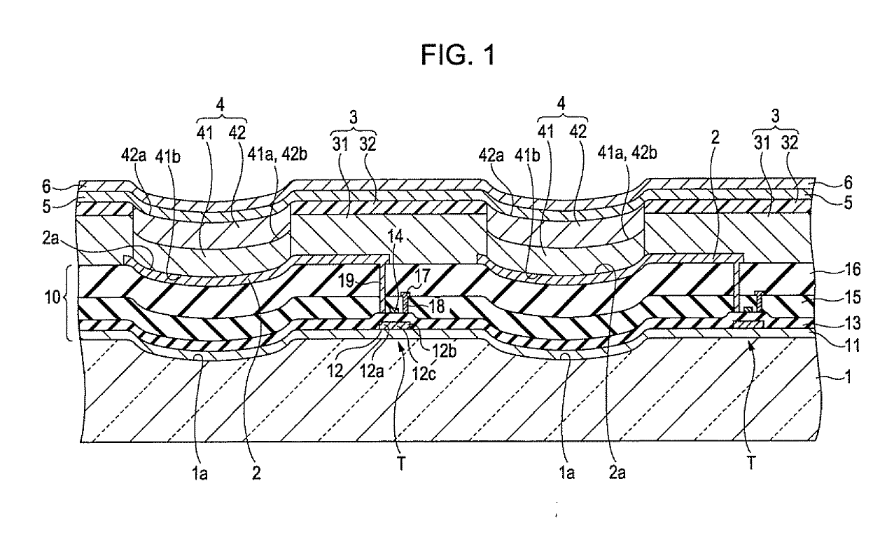

FIG. 1 is a longitudinal sectional view illustrating an electroluminescent device according to an embodiment of the invention. In this embodiment, the invention is applied to an organic EL device (organic EL emitting device) as the electroluminescent device. In particular, in the embodiment shown in the figure, the invention is applied to an active matrix organic EL device, and a thin-film transistor is used as the active element.

The organic EL device includes a substrate 1 made of glass or the like and a circuit element portion 10 having a thin-film transistor T on the upper surface of the substrate 1. The circuit element portion 10 includes a base protection film 11 made of a silicon oxide film on the substrate 1 and an island-like semiconductor film 12 made of polycrystalline silicon on the base protection film 11. The semiconductor film 12 has a source region 12a and a drain region 12b formed by high-concentration P ion implantation at both the left and right sides, as the direction shown in the figure. The central portion of the semiconductor film 12 is not implanted with P ions and functions as a channel region 12c.

The circuit element portion 10 includes a transparent gate-insulating film 13 covering the base protection film 11 and the semiconductor film 12, and includes a gate electrode (scanning line) 14 made of Al, Mo, Ta, Ti, W, or the like on the gate-insulating film 13. The gate electrode 14 is disposed at a position corresponding to the channel region 12c of the semiconductor film 12. The circuit element portion 10 further includes a transparent first interlayer-insulating film 15 and a transparent second interlayer-insulating film 16 that are disposed on the gate electrode 14 and the gate-insulating film 13. Power wire 17 is disposed on the first interlayer-insulating film 15 and is conductively connected to the drain region 12b of the semiconductor film 12 through a contact hole 18 provided to the first interlayer-insulating film 15.

Furthermore, a transparent anode (also referred to as aperture electrode or pixel electrode) 2 made of ITO or the like and having a predetermined shape formed by patterning is disposed on the second interlayer-insulating film 16. The anode 2 is conductively connected to the source region 12a of the semiconductor film 12 through a contact hole 19 provided to the first interlayer-insulating film 15 and the second interlayer-insulating film 16. Thus, the circuit element portion 10 is provided with driving thin-film transistors T that are connected to the respective anodes 2. The circuit element portion 10 also includes storage capacitor for storing an image signal and a thin-film transistor for switching, but they are not drawn in the figure.

In this embodiment, a bank 3 for partitioning pixel regions is formed on the upper surface of the circuit element portion 10 containing the anode 2 as the bank-forming face. The structure of the bank 3 is arbitrary. In this embodiment, the bank 3 has a double-layer structure composed of a lower layer 31 lyophilic to a thin-film material liquid, which will be described below, and an upper layer 32 repellent to the thin-film material liquid. The bank 3 may be made of an arbitrary material. In the bank 3 having such as an aforementioned double-layer structure, it is preferably that the lower bank layer 31 be made of an inorganic material such as SiO₂ or SiN and the upper bank layer 32 be made of an organic material such as an acrylic resin or a polyimide resin.

In the bank 3 having a lower bank layer 31 made of an inorganic material as described above, the contact angle of a thin-film material liquid to the bank can be decreased by treating the surface of the lower bank layer 31 with oxygen plasma, and thereby high lyophilicity can be attained. On this occasion, the region surrounded by the bank 3, namely, the substrate 1 and the anode 2 which are made of inorganic materials such as glass and ITO, respectively, can be imparted with lyophilicity by being simultaneously treated with oxygen plasma. Furthermore, in the bank 3 having an upper bank layer 32 made of an organic material as described above, the contact angle of the thin-film material liquid to the bank can be selectively increased by treating the surface of the upper bank layer 32 with fluorine gas plasma such as CF₄ plasma, and thereby high liquid repellency can be attained. Furthermore, a material having higher liquid repellency, such as fluorine-containing resin materials, may be used.

The top face of the anode 2 in a region surrounded by the bank 3 is provided with a concave 2a. The region surrounded by the bank 3 and having the concave 2a is filled with a thin-film material liquid using an ink-jet system, and the solution is solidified to form a thin-film layer. In this embodiment, a liquid composition for forming an organic EL layer is used in the form on a thin-film material liquid, and an organic EL layer 4 is formed as a thin-film layer. The organic EL layer 4 in this embodiment is composed of a hole-transporting layer 41 disposed on the top face of the anode 2 and a luminescent layer 42 disposed on the hole-transporting layer 41.

A cathode 5 is disposed on the top faces of the organic EL layer 4 and the bank 3 so as cover them. Consequently, the organic EL layer 4 composed of the hole-transporting layer 41 and the luminescent layer 42 is disposed between the cathode 5 and the anode 2. The anode 2, the organic EL layer 4, and the cathode 5 constitutes an organic EL element. A sealing layer 6 is disposed on the top face of the cathode 5. The structure of the organic EL layer 4 can be arbitrarily modified. For example, the organic EL layer 4 may have a structure including a hole-injecting/transporting layer or both a hole-transporting layer 41 and a hole-injecting layer, instead of the hole-transporting layer 41; a structure including an interlayer between such a layer and the luminescent layer 42; or a structure including an electron-transporting layer or an electron-injecting layer between the luminescent layer 42 and the cathode 5. The organic EL element of this embodiment is a so-called bottom emission-type in which light is emitted from the bottom side, but may be a top emission-type in which light is emitted from the top side.

The top face of the thin-film layer that is formed by filling a region surrounded by the bank 3 with a thin-film material liquid and solidifying the liquid has a concave recess, as in a known thin-film layer. For example, in a case that the thin-film layer constitutes an organic EL layer 4 composed of a hole-transporting layer 41 and a luminescent layer 42, as described in the above embodiment, the hole-transporting layer 41 is first formed. On this occasion, a recess 41a is formed on the top face of the hole-transporting layer 41 as in the thin-film layer shown in FIG. 5. However, the bottom face side of the hole-transporting layer 41 is curved along the concave 2a, so that the central portion is convexed downward to form a convex 41b. Therefore, the thickness of the hole-transporting layer 41 is substantially uniformized not to have a difference in the thicknesses at the central portion and the peripheral portion by the convex 41b and the recess 41a. Thus, a difference in the thicknesses can be reduced, unlike the known thin-film layer.

Similarly, a recess 42a concaving in the central portion is formed on the top face of the luminescent layer 42 on the hole-transporting layer 41 due to the bank 3 as in the hole-transporting layer 41. The bottom face side of the luminescent layer 42 is curved along the recess 41a of the top face of the hole-transporting layer 41, so that the central portion is convexed downward to form a convex 42b. With this, the thickness of the luminescent layer 42 is also substantially uniformized not to have a difference in the thicknesses at the central portion and the peripheral portion. As a result, an electroluminescent element such as an aforementioned organic EL element can have a uniform emission profile without unevenness of brightness.

The concave 2a is preferably formed so as to have a shape substantially identical to that of the recess 41a. For example, in a case that the recess 41a has an elliptical cross-section as shown in FIG. 5, the concave 2a and/or the convex 41b is preferably formed to have an elliptical cross-section corresponding to the recess 41a. In a case that the recess 41a has a spherical shape having a predetermined radius R and a predetermined opening angle θ, the concave 2a and/or the convex 41b is preferably formed to have a spherical shape corresponding to the recess 41a. As a result, the thickness of the thin-film layer can be more certainly uniformized.

Furthermore, the side faces of the upper layer and the lower layer of the bank preferably have a substantially single flat surface as shown in FIG. 1, not to have unevenness therebetween. When the lower layer and the upper layer of the bank have a substantially single flat surface and there is no unevenness therebetween, a thin-film layer is not formed on the side face of the upper layer having liquid repellency and is formed only on the side face of the lower layer having lyophilicity, in the region surrounded by the bank. In addition, the thin-film layer is not formed on the top face of the lower layer and also is not exposed to the outside of the region surrounded by the bank by forming the side faces having a substantially single flat surface. As a result, for example, in an organic EL element, occurrence of unevenness of brightness caused by a film spreading to the outer side than the anode in the bank can be avoided as much as possible.

In the above embodiment, the invention is applied to an active matrix organic EL device, but the invention can be also applied to a passive organic EL device. In such a case, for example, anode 2 is disposed on a substrate 1, and a bank 3 is disposed on the top face of the anode 2 without having the above-mentioned circuit element portion 10. An organic EL layer 4 is formed in a region surrounded by the bank 3. A cathode 5 is dispose on the top faces of the bank 3 and the organic EL layer 4, and a sealing layer 6 is disposed on the cathode 5.

### Method of Manufacturing Electroluminescent Device

Next, a method of manufacturing the electroluminescent device according to an embodiment of the invention will be specifically described with reference to an example of manufacturing an aforementioned organic EL device. In an active matrix organic EL device such as shown in FIG. 1, a circuit element portion 10 is first formed on a substrate 1, and then an anode 2 is formed on the top face of the circuit element portion 10. The process of forming the circuit element portion 10 is already publicly known, and, therefore, description thereof is omitted. In a passive organic EL device, the circuit element portion 10 is not provided, and an anode 2 is formed, directly or through a protection layer or the like, on the surface of a substrate 1.

On this occasion, a concave 2a is formed on the top face of the anode 2. When a film such as the anode 2 or the interlayer-insulating film that constitutes the circuit element portion 10 has a relatively large thickness, the concave may be formed by etching or debossing the film surface. When these films are too thin to form a concave, for example, a concave 1a is formed on the surface of the substrate 1, and an anode 2 in a passive type or a circuit element portion 10 and an anode 2 in an active type are formed on the concave 1a. Thus, the shape of the concave 1a of the substrate 1 is reproduced on the top face of the anode 2 to form a concave 2a on the top face of the anode 2.

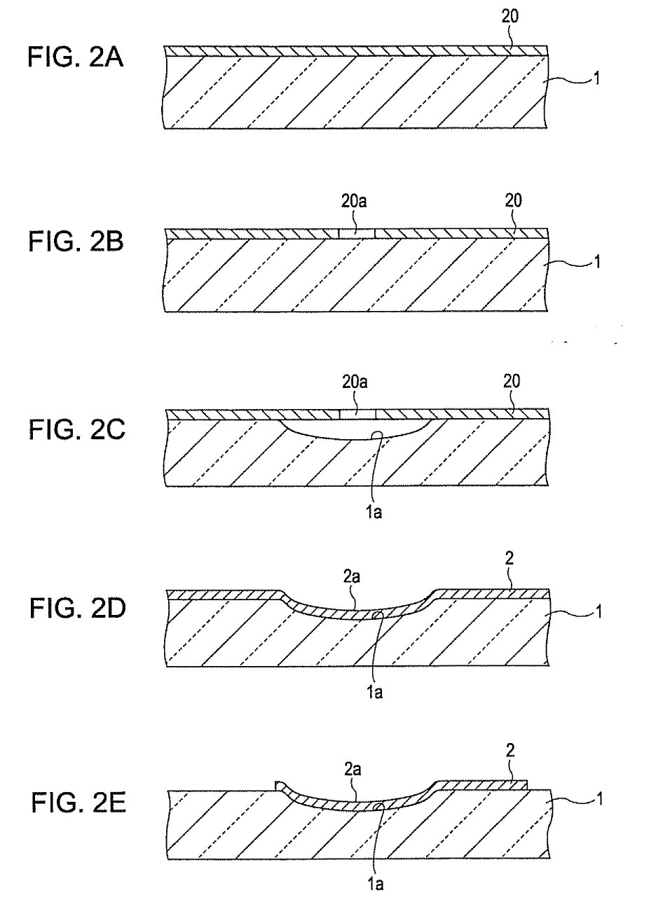

FIGS. 2A to 2E show an example of a process of forming a substrate 1 and an anode 2 for a passive type according to the above description First, as shown in FIG. 2A, a masking layer 20 made of polycrystalline silicon or the like is formed on the top face of a glass substrate 1. Then, as shown in FIG. 2B, an aperture 20a is formed in the masking layer 20 by photoresist patterning at a position corresponding to the position where the aforementioned concave 1a is formed. Then, as shown in FIG. 2C, a concave la is formed on the top face of the glass substrate 1 by etching the substrate 1 through the aperture 20a, and then the masking layer 20 is removed. Then, as shown in FIG. 2D, an anode 2 having a predetermined thickness is formed by coating an electrode-forming material such as ITO on the top face of the substrate 1 by spin coating or the like and by drying and solidifying the material. As a result, the shape of the concave 1a of the substrate 1 is reproduced on the surface of the anode 2 to form a concave 2a on the top face of the anode 2. Then, as shown in FIG. 2E, the anode 2 is patterned into predetermined size and shape by etching or the like.

In a case that a circuit element portion 10 is disposed between a substrate 1 and an anode 2 as in the device shown in FIG. 1, a concave 1a is formed on the surface of the substrate 1 as in above. The circuit element portion 10 is formed on the top face of the substrate 1 by a known process, and then the anode 2 is formed by the same manner as in above. As a result, the shape of the concave 1a of the substrate 1 is reproduced on the surface of the anode 2 through the circuit element portion 10 and the anode 2 to form a concave 2a on the top face of the anode 2. The device shown in FIG. 1 is thus formed. When any layer or film that constitutes the circuit element portion 10, for example, the first interlayer-insulating film 15 or 16 or the anode 2, has a relatively large thickness as mentioned above, a concave may be formed in such a layer or film or the anode 2 so that the shape of the concave is formed on the surface of the anode 2, without forming a concave 1a on the substrate 1 as in above.

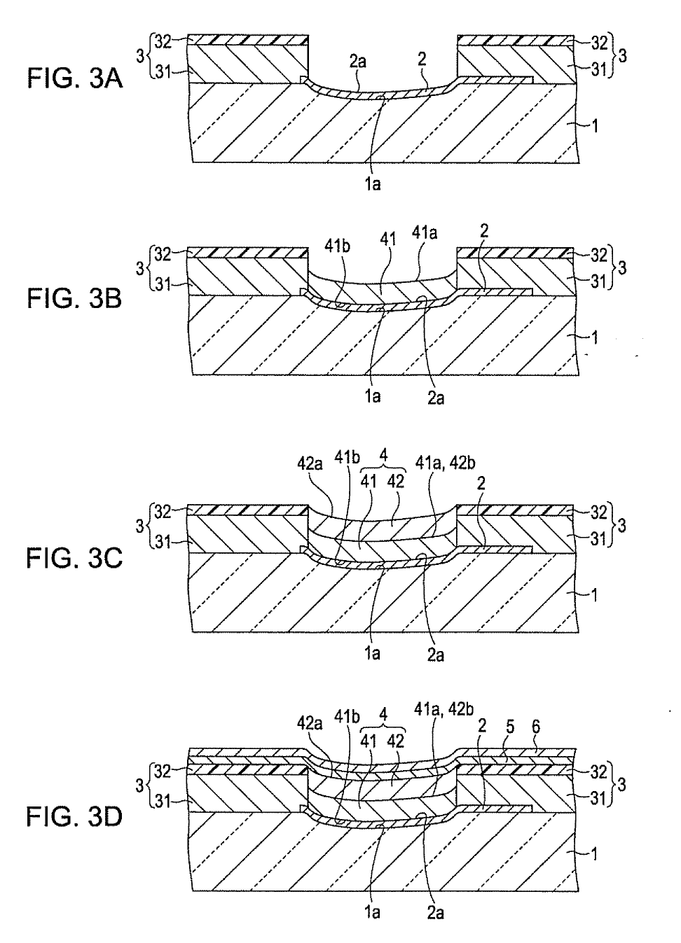

Then, a bank 3 for partitioning pixel regions is formed on the substrate 1 functioning as a bank-forming face at the periphery of the anode 2 patterned into predetermined size and shape by the same manner as in above so that the bank 3 surrounds the concave 2a. In a case that a bank has a double-layer structure composed of a lower bank layer 31 having lyophilicity to a thin-film material liquid and a upper bank layer 32 having liquid repellency to the thin-film material liquid as in the device shown in FIG. 1, for example, the lower bank layer 31 is formed on the substrate 1 by photolithography or the like, and then the upper bank layer 32 is similarly formed on the lower bank layer 31 by photolithography or the like to form the bank 3 having the double-layer structure as shown in FIG. 3A.

In this embodiment, the lower bank layer 31 is made of an inorganic material such as SiO₂ or SiN, and the surface of the layer is treated with oxygen plasma to be imparted with high lyophilicity to the thin-film material liquid. On this occasion, the surface of the substrate 1 of glass or the like that has an anode 2 made of ITO or the like on the surface thereof is simultaneously treated with oxygen plasma and thus is imparted with lyophilicity. The upper bank layer 32 is made of an organic material such as an acrylic resin or a polyimide resin, and the surface of the upper bank layer 32 is treated with fluorine gas plasma such as CF₄ plasma to be imparted with high liquid repellency to the thin-film material liquid. The previously obtained lyophilicity by the oxygen plasma treatment is not decreased by the fluorine gas plasma treatment.

After forming the bank 3 that has the double-layer structure composed of the lower bank layer 31 having lyophilicity to a thin-film material liquid and the upper bank layer 32 having liquid repellency to the thin-film material liquid on the substrate 1 having the anode 2 on the surface thereof as described above, an organic EL layer 4 is formed in a region surrounded by the bank 3. For example, in a case that the organic EL layer 4 is composed of a hole-transporting layer 41 and a luminescent layer 42 as described above, the hole-transporting layer 41 and the luminescent layer 42 are sequentially formed using an ink-jet system or the like by filling the above region with the respective thin-film material liquids, which are liquid compositions each prepared by dissolving or dispersing an organic material for forming the layer in a solvent, and then solidifying the liquid.

Specifically, a hole-transporting layer 41 is first formed by ejecting a thin-film material liquid for the hole-transporting layer 41, for example, from a head of an ink-jet printing apparatus, which is not shown in the figure, to fill a region surrounded by the bank 3 shown in FIG. 3A with the liquid; and drying and solidifying the thin-film material liquid by a drying step and an annealing step to give the hole-transporting layer 41 as shown in FIG. 3B. As a result, a recess 41a is formed on the top face of the hole-transporting layer 41 due to the region surrounded by the bank 3 and the lyophilicity of the lower bank layer 31, and the bottom face of the hole-transporting layer 41 has a convex 41b curving downward at the central portion of the bottom face due to the concave 2a formed in the region surrounded by the bank 3. Accordingly, the hole-transporting layer 41 can have an approximately uniform thickness without a difference in the thicknesses of the central portion and the peripheral portion.

Then, a luminescent layer 42 is formed as shown in FIG. 3C by applying a thin-film material liquid for the luminescent layer 42 on the top face of the hole-transporting layer 41 using an ink-jet system or the like as in above and solidifying the liquid by a drying step and an annealing step. As a result, a depression 42a is also formed on the top face of the luminescent layer 42 due to the lyophilicity of the lower bank layer 31, and the bottom face of the luminescent layer 42 has a convex 42b curving downward at the central portion of the bottom face due to the recess 41a of the hole-transporting layer 41. Accordingly, the luminescent layer 42 can have an approximately uniform thickness without a difference in the thicknesses of the central portion and the peripheral portion.

Then, as shown in FIG. 3D, a cathode 5 is formed substantially on the entire top faces of the organic EL layer 4 composed of the hole-transporting layer 41 and the luminescent layer 42 and the bank 3 composed of the lower bank layer 31 and the upper bank layer 32 by vacuum vapor deposition or the like, and a sealing layer 6, as a protection film, is formed on the surface (top face) of the cathode 5. The sealing layer 6 may be formed by an arbitrary method, for example, by vapor-depositing a barrier film on the surface of the cathode 5, or publicly known passivation or can-sealing.

The structure of the organic EL layer 4 can be arbitrarily modified as described above. For example, in a case that a hole-injecting/transporting layer or both a hole-transporting layer 41 and a hole-injecting layer are provided instead of the hole-transporting layer 41, similar function and effect can be attained by forming these layers by the same manner as in the hole-transporting layer 41. In a case that an interlayer is formed between such a layer and the luminescent layer 42, the interlayer may be formed before the formation of the luminescent layer 42. In a case that an electron-transporting layer or an electron-injecting layer is formed between the luminescent layer 42 and the cathode 5, each layer may be formed after the formation of the luminescent layer 42. In these cases in which those layers are formed, similar function and effect can be attained.

In the above embodiment, an ink-jet system was used for filling a region surrounded by the bank with a thin-film material liquid, but the method is not limited thereto. For example, a spin coating method or a dipping method may be employed. Furthermore, the bank 3 is not limited to that having a double-layer structure. The bank 3 may be a monolayer structure or a three-layer structure. In addition, any material may be arbitrarily used, but it is desirable that at least the lower portion of the bank and the region surrounded by the bank are lyophilic to the thin-film material liquid.

In the above embodiment, an example in which the invention is applied to an organic EL device as the electroluminescent device, but the electroluminescent device is not limited to this, and the invention can be applied to, for example, an LED device using an LED element or other electroluminescent devices.

### Electronic Device

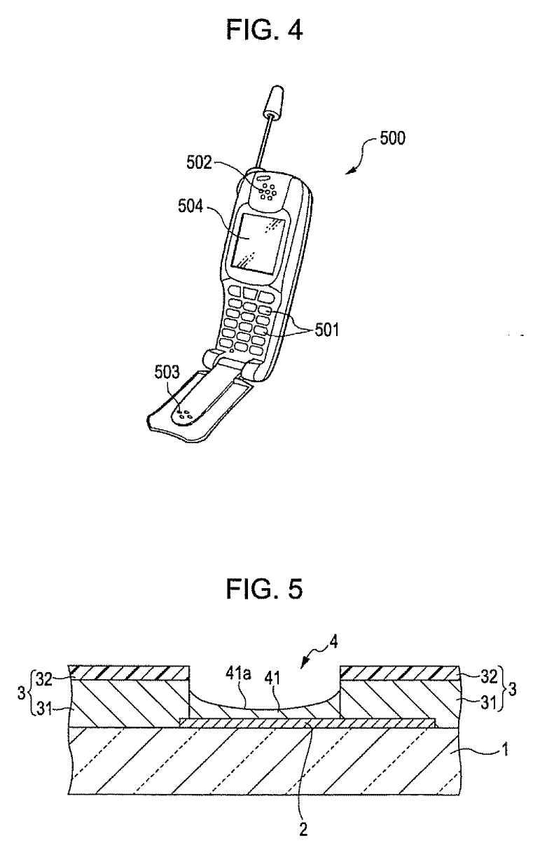

Furthermore, the invention can be applied to an electronic device having an electroluminescent device described above. FIG. 4 is a perspective view of a mobile phone as an embodiment of the electronic device. This embodiment is a case in which an organic EL device as the electroluminescent device is applied to a display 504 of the mobile phone 500. The mobile phone 500 includes a plurality of operation buttons 501, an earpiece 502, and a mouthpiece 503, in addition to the display 504.

The invention is not limited to the mobile phone described above and can be widely applied to other various electronic devices, such as mobile information devices such as PDAs, computers such as note-type personal computers, workstations, digital still cameras, digital video cameras, televisions, video tape recorders, in-car monitors, in-car navigation systems, pagers, electronic books, electronic notepads, calculators, word processors, video phones, and POS terminals.

### Thin-Film Structure

Furthermore, the invention is not limited to electroluminescent devices and electronic devices described above and can be applied to various types of thin-film structures and methods for forming thin-films as long as where a bank is formed on a bank-forming face provided on one surface of a substrate, and a thin-film layer is formed at a region surrounded by the bank. Specifically, the thin-film structure according to an embodiment of the invention includes a substrate having a bank-forming face on one surface thereof, a bank disposed on the bank-forming face, and a thin-film layer formed by filling a region surrounded by the bank with a thin-film material liquid and solidifying the liquid, and is characterized by that the bank-forming face of the region surrounded by the bank and a contact face with the thin-film layer have curved surfaces so that the substantially central portions thereof are convexed toward the substrate side. With such a structure, the thickness of the thin-film layer can be further uniform, as in the aforementioned electroluminescent device.

The curved surfaces in the thin-film structure are also preferably formed, as in the electroluminescent device, so as to have a shape substantially identical to that of the recess on the top face of the thin-film layer formed by filling a region surrounded by the bank with a thin-film material liquid and solidifying the liquid. For example, the bank may be composed of a lower layer lyophilic to the thin-film material liquid and an upper layer repellent to the thin-film material liquid. The lower bank layer may be made of an inorganic material such as SiO₂ or SIN, and the upper bank layer may be made of an organic material such as an acrylic resin or a polyimide resin. Furthermore, the side faces of the lower layer and the upper layer of the bank can form a substantially single flat surface. The bank-forming face is constituted by a substrate having an electrode on the surface thereof, and at least a surface of the electrode is provided with the aforementioned curve. In all the above cases, the aforementioned function and effect can be attained.

### Method of Forming Thin Film

A method of forming a thin film according to an embodiment of the invention includes forming a bank on a bank-forming face and forming a thin-film layer by filling a region surrounded by the bank with a thin-film material liquid and solidifying the liquid, wherein the surface of the region surrounded by the bank is provided with a concave. With such a structure, as in the method of manufacturing an electroluminescent device, a recess is formed on the top face of the thin-film layer, and a convex corresponding to the concave is formed on the bottom face of the thin-film layer. As a result, as in above, the thickness of the thin-film layer can be readily uniformized.

The bank-forming face in the above method of forming a thin film is also constituted by a substrate having an electrode on the surface thereof, and the concave is formed at least on the surface of the electrode, as in the method of manufacturing an electroluminescent device. In such a case, the concave may be formed on the surface of the electrode or may be formed by forming a concave on the surface at the electrode side of the substrate and forming the electrode of a thin film on the concave so that the shape of the concave of the substrate is reproduced on the surface of the electrode to form a concave on the surface of the electrode. The region surrounded by the bank can be filled with the thin-film material liquid using an ink-jet system. In all the above cases, the aforementioned function and effect can be attained.

Furthermore, the invention can be applied to electronic devices including the above-described thin-film structure or a thin-film layer formed by the above-described method for forming a thin film, and therefore an electronic device including a thin-film layer with a substantially uniform thickness without unevenness can be provided.

The entire disclosure of Japanese Patent Application No: 2007-086786, filed Mar. 29, 2007 is expressly incorporated by reference herein.

What is claimed is:

1. An electroluminescent device comprising:
a substrate having a bank-forming face on one surface thereof;
a bank formed on the bank-forming face; and
a thin-film layer constituting an electroluminescent element at a region surrounded by the bank, wherein
the thin-film layer is formed by filling the region surrounded by the bank with a thin-film material liquid and solidifying the liquid, and
the bank-forming face and a contact face with the thin-film layer have curved surfaces so that the central portions thereof are convexed toward the substrate side.

2. The electroluminescent device according to claim 1, wherein the curved surfaces have a shape substantially identical to that of a recess on the surface of the thin-film layer.

3. The electroluminescent device according to claim 1, wherein the bank has a structure including a lower layer that is lyophilic to the thin-film material liquid and an upper layer that is repellent to the thin-film material liquid.

4. The electroluminescent device according to claim 3, wherein the lower layer of the bank is made of SiO₂ or SiN, and the upper layer of the bank is made of an acrylic resin or a polyimide resin.

5. The electroluminescent device according to claim 3, wherein the side face of the lower bank layer and the side face of the upper bank layer form a substantially single flat surface.

6. The electroluminescent device according to claim 1, wherein the bank-forming face includes an electrode formed on the substrate, and the curved surface is formed at least on the surface of the electrode.

7. The electroluminescent device according to claim 1, wherein the thin-film layer is an organic EL layer constituting an organic EL element as an electroluminescent element.

8. A method of manufacturing an electroluminescent device comprising:
forming a bank on a bank-forming face; and
filling a region surrounded by the bank with a thin-film material liquid and solidifying the liquid to form a thin-film layer constituting an electroluminescent element, wherein
a concave is formed on the surface of the region surrounded by the bank, and the thin-film layer is formed on the concave.

9. The method of manufacturing an electroluminescent device according to claim 8, wherein the bank-forming face is constituted with a substrate including an electrode on the surface thereof, and the concave is formed at least on the surface of the electrode.

10. The method of forming an electroluminescent device according to claim 8, wherein the region surrounded by the bank is filled with the thin-film material liquid using an ink-jet system.

11. An electronic device comprising the electroluminescent device according to claim 1.

12. A thin-film structure comprising:
a substrate having a bank-forming face provided on one surface thereof;
a bank formed on the bank-forming face; and
a thin-film layer formed by filling a region surrounded by the bank with a thin-film material liquid and solidifying the liquid, wherein
the bank-forming face and a contact face with the thin-film layer have curved surfaces so that the substantially central portions thereof are convexed toward the substrate side.

13. A method of forming a thin film comprising:
forming a bank on a bank-forming face; and
forming a thin-film layer by filling a region surrounded by the bank with a thin-film material liquid and solidifying the liquid, wherein
the surface of the region surrounded by the bank is formed into a concave face.
